(19) United States
(12) Patent Application Publication
(10) Pub. No.: US 2004/0224833 A1
(43) Pub. Date: Nov. 11, 2004

(54) Process for producing a glass by mixing molten glasses

(75) Inventors: Pierre Jeanvoine, Poissy (FR); Luis Grijalba Goicoechea, Aviles (ES); Ramon Rodriguez Cuartas, Aviles (ES); Maurice Lemaille, Castrillon Asturias (ES)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/829,955

(22) Filed: Apr. 23, 2004

Related U.S. Application Data
(63) Continuation of application No. PCT/FR04/00420, filed on Feb. 25, 2004.

(30) Foreign Application Priority Data
Feb. 27, 2003 (FR) 03 02373

(51) Int. Cl. C03C 3/085; C03C 3/087

(52) U.S. Cl. 501/70; 65/121; 65/99.1; 501/71

(57) ABSTRACT

The invention relates to a plant and to a process for manufacturing a glass, comprising the production of a main stream of a liquid main glass, by a main plant that includes a main furnace, and the production of an auxiliary stream of a liquid auxiliary glass, by an auxiliary plant that includes an auxiliary furnace having a submerged burner, the auxiliary stream being smaller than the main stream, the auxiliary glass having a composition different from that of the main glass and the two streams then being mixed to form a single total stream of the final glass. The auxiliary furnace especially provides the function of coloring the main glass so that the final glass is a colored glass. A highly homogeneous and bulk-colored flat glass may thus be manufactured by an installation having short transition times.

The invention relates to a process and to a plant for producing glass, with a high productivity and a low transition time, for making a very homogeneous glass without any optical defects, especially flat glass, by mixing two liquid glasses of different compositions.

The production of a glass from two different glasses is especially carried out for producing colored glass. Colored glass may be produced in various ways. It is possible to add a solid glass frit to the main glass stream, said frit melting and mixing gradually into the main glass. The frit is introduced cold with a low dose into a coloring cell located in the actual end feeder of the furnace, just before the glass is fed into the forming machines. The frit is usually in the form of solid pieces and contains most of the pigment generating the color of the final glass. However, even when homogenizing means (stirrers) are used, it is very difficult for the two glass streams to be mixed effectively, so that the final glass is not very homogeneous in terms of color and is not suitable for many applications. In general, this type of manufacture is reserved for hollowware (flasks, bottles, etc.) or printed flat glass (cast glass) and more generally to glass converted into small articles for which the requirements of color homogeneity are lower, whereas it is unsuitable for flat glass of large size. U.S. Pat. No. 3,627,504 teaches the addition of frits to a stream of molten glass.

To produce a colored flat glass, it is also possible to deposit at least one layer of colored material on the surface of a clear glass—the flat glass, which appears colored, is not bulk-colored but draws its color from a particular surface layer.

Finally, to produce a colored flat glass it is also possible to introduce coloring materials at the front end of the furnace together with the batch materials. However, in this type of manufacture, the transition times corresponding to a change of tint are always very long, mainly because of the high ratio of the mass of glass in the furnace to the mass of glass pulled per day (particularly in flat glass furnaces). Often several days are needed, this being the cause of a substantial loss of glass since the transition glass is unsuitable for being sold. In particular, decoloration (return of a tinted glass to a clear glass) takes a particularly long time. This is because in such a case there is no means of speeding up the return to clear glass, whereas, when coloring glass, it is possible to make use of color concentrates (introduction of coloring agents with a concentration temporarily greater than that of the final glass), thereby speeding Up the coloring process. This problem of a long transition time is more important in the case of tints that absorb in the infrared, such as for example the color green. In fact, the manufacture of infrared-absorbing glasses, such as green automotive glass or glass for bottles and flasks, leads to a reduction in heat transfer from the flames to the floor of the furnace, thereby lowering the temperature of the glass near this floor, thus making it more viscous and therefore less mobile. This results in braking of the convection belts and a reduction in the maximum possible output. A green automotive glass containing 0.6% iron oxide and having an Fe²⁺ redox of 0.30 (the Fe²⁺ redox is the ratio of the amount of Fe²⁺ ions to the total amount of iron ions) is thus manufactured in a float glass furnace with a pull rate of about 10 to 15% less than for a clear glass containing only 0.1% iron oxide, for the same cullet content. In addition, the highly absorbing nature of the glass means that either the output has to be lowered or the depth of glass to be heated has to be limited.

The problem of long transition times (mentioned above in the case of a change in the coloring of a glass) arises in the general context of a change in the composition of a glass and especially in the absorptivity of a glass. This is because, whenever it is desired to change the composition of a glass, especially for the purpose of changing its ability to absorb at least certain wavelengths by the addition of material to the main glass, difficulties are encountered in making this change very homogeneous throughout the bulk, this problem being more acute the higher the pull rate and when the glass is converted into large articles, especially made of flat glass. The problem of long transition times also arises in general. Moreover, if a particular compound or additive for the composition (conferring, as appropriate, absorptivity) has the drawback of being corrosive with respect to the refractories, its addition in the batch charging end of a large furnace has a negative impact on the entire large furnace. From this standpoint, the invention makes it possible in particular to spare a substantial mass of refractory (that of the main large plant) by confining the presence of the harmful material to an auxiliary plant of smaller size and in the downstream part of the manufacturing plant (the forming station feeder and the forming station, and also a possible mixing cell). In particular, it may be necessary to use as raw materials those containing metals (for example contaminated or less well sorted cullet, such as fragments of bottles contaminated With a metal from the metal cap), the latter possibly having a tendency to accumulate on the floor of the furnace and infiltrate the joints of the refractories, which may damage them or even puncture them. By confining these harmful materials to the small auxiliary plant, the overall wear of the refractories is less.

Likewise, if the melting of certain particular compounds (or additives) requires temperatures that are too high for the main furnace, may be preferable to introduce them into the final glass by means of the auxiliary plant, especially when this is equipped with submerged burners of high calorific value.

The invention solves the abovementioned problems. According to the invention, the transition times for a composition change are reduced and, in addition, high glass pull rates, even during the production of infrared-absorbing glasses (especially green glass containing iron oxide, generally a mixture of ferrous oxide and ferric oxide), are possible. This is because, in the conventional melting of the prior art, if the infrared-absorbing pigment is introduced in the batch charging end (at the front of the furnace) like the other batch materials, the atmospheric burners will have a great difficulty in heating in the depths of the liquid glass (owing to the absorption by the glass itself), so that it is necessary either to lower the pull rate or to provide shallower depths of liquid glass. According to the invention, the absorbing element may be mainly fed into the final glass via an auxiliary plant of lower pull rate than the main furnace, it then being possible for the latter to maintain high pull rates and large glass depths. Thus, the main furnace may maintain a high specific pull rate, possibly ranging from 1.4 to 2 t/d.m², and operate with a great depth of molten glass, possibly greater than 1 metre, since the infrared-absorbing element, such as iron oxide, is brought in via the auxiliary glass. The auxiliary furnace is advantageously of the type with submerged burners as such a furnace has a high specific pull rate for a low volume, which further helps to reduce the transition times. This advantage is particularly important if a comparison is made with an electric furnace. In addition, the electrodes of such an electric furnace (which are generally made of Mo) are rapidly worn away in the presence of an auxiliary glass with a high iron concentration, as is especially the case within the context of the present invention.

Within the context of the present application, the change to the main glass is made by the addition of an auxiliary glass, the mixture of these two glasses being called the final glass. Thus, the invention relates to a plant and to a process for manufacturing a final glass, comprising the production of a liquid main glass by a main plant comprising a main furnace generating a main stream of glass (called “main glass”) and the production of a liquid auxiliary glass by an auxiliary plant comprising an auxiliary furnace generating an auxiliary stream of glass (called the “auxiliary glass”), the auxiliary stream being smaller than the main stream, the auxiliary glass having a composition different from that of the main glass and the two streams then being mixed to form a single total stream of the final glass. The composition of the final glass is different from that of the main glass as it is modified by the addition of the auxiliary glass. Owing to this modification, the absorbent nature of the final glass may, depending on the case, be different from that of the main glass.

The auxiliary glass has a composition different from that of the main glass as regards at least one compound (which may also be called “particular compound” in the present application). Thus, the invention relates to the modification in the content of at least one compound (or additive) in the main glass, said modification resulting in the final glass.

The function of the auxiliary glass may be to increase the content of a particular compound of the main glass, in which case the content of said compound is higher in the auxiliary glass than in the final glass and the content of said compound is higher in the final glass than in the main glass. In particular, the auxiliary glass may be a coloring glass that has to color the main glass. In this situation, in which it is desired to make the content of a compound increase from the main glass to the final glass, and to further reduce the transition time between two manufacturing runs using the same main glass, it is possible to momentarily overdose the compound in question in the auxiliary glass at the start of the second manufacturing run in order for the content of said compound in the final glass to be reached more rapidly. Thereafter, the content of said compound in the auxiliary glass is reduced in a controlled manner in order to maintain the desired content of said compound in the final glass.

The function of the auxiliary glass may be to lower the content of a particular compound in the main glass, in which case the content of said compound is higher in the main glass than in the final glass and the content of said compound is higher in the final glass than in the auxiliary glass. In particular, the main glass may be an already colored glass that it is desired to decolor by adding a clear auxiliary glass to it.

The total stream generally feeds a glass forming station for making hollowware or flat glass. The forming station may therefore in particular be a continuous flat glass forming station, such as a float glass installation. In such an installation, a flat glass is produced continuously as a wide ribbon with a width of greater than 1 metre, generally greater than 2 metres and more generally greater than 3 metres. Preferably, at the moment when the two liquid (molten) glasses are mixed, their temperatures are similar, that is to say they do not differ by more than 100° C. from each other, and they also have similar viscosities. In general, the two streams have temperatures between 1100 and 1300° C. and even between 1100 and 1200° C.

If the final glass contains a compound giving it an absorbent character, it may also be called an absorbent glass.

The invention relates in particular to the modification of the absorbent nature of a main glass, either its decrease or its increase, it being understood that the decrease is accompanied by a lowering of the content of a particular compound and the increase is accompanied by an increase in the content of said compound.

The auxiliary glass may in particular modify the absorptivity of the main glass. This relates to the absorptivity with respect to any type of radiation, that is to say that having wavelengths in the visible or in the UV or in the infrared, or that of X-rays or α- or β- or γ-rays, or that having wavelengths in at least two of these ranges.

If it is desired to increase the absorbent nature of the main glass, an auxiliary glass more absorbent than it is used, so that the final glass is less absorbent than the auxiliary glass but more absorbent than the main glass. This order in the absorbent nature of the three glasses is mirrored in their respective contents of the compound that results in the absorbent nature in question. Thus, the process according to the invention may especially be a process for coloring a glass, the content of a certain pigment of which is increased when going from the main glass to the final glass.

If it desired to reduce the absorbent nature of the main glass, an auxiliary glass less absorbent than it is used, so that the final glass is more absorbent than the auxiliary glass but less absorbent than the main glass. This order in the absorbent nature of the three glasses is mirrored in their respective contents of the compound causing the absorbent nature in question. Thus, the process according to the invention may especially be a process for decoloring a glass, the content of a certain pigment of which is lowered and going from the main glass to the final glass. This possibility has in particular a following benefit: if a main furnace manufactures a main glass containing a high content of a compound (for example 2% by weight of iron oxide) and there is sometimes a need for a final glass with a lower proportion of said compound (for example, a final glass containing 1% by weight of iron oxide), this glass can be easily manufactured by adding to the main glass an auxiliary glass containing even less of said compound (for example 0% of iron oxide), without interrupting or disturbing the operation of the main furnace. When the desired volume has been produced, the addition of the auxiliary glass is stopped and thus the previous manufacture is resumed, once again without disturbing the operation of the main furnace.

As in the use of glass frits according to the prior art (within the context of coloration), the composition of a glass (and where appropriate its absorptivity) is modified no longer using the raw material charged into the melting furnace, but into the terminal zone of the furnace. However, within the context of the present invention:

a frit is no longer used, rather an auxiliary matrix glass (having a chemical composition excluding particular elements such as additives or particular compounds) identical to or similar to that of the final glass to be manufactured;

the auxiliary glass is introduced hot and molten into the main glass; and

the auxiliary glass is produced in a separate installation, alongside the main furnace and where necessary close to the mixing cell. In particular, the plant for producing the auxiliary glass may be small, most particularly when the technology of submerged burners is employed, thereby generally making it possible to add it next to the main plant without modifying the general infrastructure.

In addition, even within the context of coloration, the use of coloring pigments, such as a coloring oxide, is less expensive than the use of frits.

The main furnace is in general heated mainly by at least one atmospheric burner (sometimes also called an air burner, this type of burner not being submerged), which means that at least half of the thermal energy supplied to this furnace is by at least one atmospheric burner. If necessary, the main furnace may be such that its heating means is exclusively formed from atmospheric burners.

The main furnace is a melting furnace generally comprising a melting zone and refining zone located after the melting zone. This main furnace generally has a floor area ranging from 200 to 600 m², especially between 300 and 500 m². If necessary, this melting furnace may be followed by a conditioning zone or working end for thermal conditioning the floor area of which may range, for example, from 50 to 300 m², depending on the size of the installation. The main plant, which may comprise a main furnace followed by a conditioning zone, may have a floor area ranging from 250 to 900 m².

In the case of the auxiliary furnace that generates the auxiliary glass, it is possible to choose a conventional, all electric or partly electric, melting technology. This type of furnace generally provides a sufficient level of refining (low content of bubbles in the final article).

However, the auxiliary furnace that generates the auxiliary glass preferably includes at least one submerged burner. Preferably, this auxiliary furnace is mainly heated by at least one submerged burner, which means that at least a part, especially at least half, of the thermal energy fed into this furnace is via at least one submerged burner. The auxiliary furnace may be such that its heating means may consist only of submerged burners. In fact, choosing the submerged combustion technology is advantageous firstly because of its possibly high specific pull rate (which may, for example, exceed that corresponding to 15 t/d.m² of soda-lime glass cullet), for example possibly ranging from 5 to 20 t/d.m², which entails a short transition time (for switching from one manufacture to another, for example from one color to another), since the ratio of the mass of glass resident in the furnace to the mass of glass pulled is then greatly reduced: this is advantageous as it is the transition time of the auxiliary furnace that in fact determines the overall transition time of the entire plant. This submerged burner technology is also advantageous within the context of the invention owing to the powerful mixing effect that the submerged combustion technology provides, and this leads to better homogeneity of the auxiliary glass.

As a result of the highly convective heat transfer provided by the stirring from the submerged burner, there is no particular difficulty in melting glasses that are strongly absorbent in the infrared, this being particularly desirable since coloring glasses are generally rich in colorants such as iron oxide. This is because, if the heating means is more particularly radiative (the case of atmospheric burners and submerged electrodes), steep temperature gradients within the bulk of the molten glass may be observed, these being prejudicial to its homogeneity.

Finally, the design of a furnace with submerged burners is simple as it involves small areas and no very hot superstructure. As an example, a furnace with submerged combustion melting soda-lime cullet with an output of 100 t/d may have an area not exceeding 6 m².

The auxiliary furnace is a melting furnace and generally has a floor area ranging from 1 to 50 m², and therefore possibly less than 6 m². Before the two glass streams are mixed, the auxiliary glass is preferably refined in a refining cell or refiner. The refiner may have a floor area ranging from 1 to 50 m². Thus, the auxiliary plant, which may comprise an auxiliary furnace followed by a refiner, may have a floor area ranging from 2 to 100 m².

One particularly suitable refining process for following a furnace comprising at least one submerged burner is vacuum refining, as described in WO 99/35099. The refining system having the minimum amount of resident glass is the best, again in order to shorten the transition time. Vacuum refining, whether static or including a dynamic rotating member, is preferred.

The auxiliary glass may be poured into the feeder taking the main stream to the forming station. If necessary, the auxiliary glass and the main glass may both be poured into a mixing cell (which may also be called a coloring cell when the modification of the composition corresponds to a color change) placed before the forming station. In all cases, the mixing of the two glasses within the final glass is made homogeneous by means of stirrers, before the glass reaches the forming station.

The mixing cell may be a compartment of approximately square or rectangular shape (seen from above) and is equipped with stirrers powerful enough to homogenize effectively. The size of this cell and the number of stirrers depend on the output. Its operating temperature will generally be from 1100° C. to 1300° C., especially around 1200° C.

The stirrers (that may be in the optional mixing cell) may especially be vertical and comprise several levels of inclined blades, in opposite directions going from one stirrer to another, in order to produce vertical and horizontal mixing simultaneously. These stirrers, may, for example, be made of rhodiated platinum, of a refractory metal alloy or of a structural ceramic (alumina, mullite-zirconium, mullite, etc.). In the latter two cases, a plasma deposition of platinum is carried out in order to ensure inertness on contact with the glass, after suitable barrier layers have been deposited.

The molten auxiliary glass is introduced into the main glass in such a way as to avoid forming bubbles.

The final glass, obtained after mixing the main glass and the auxiliary glass, must be homogeneous (especially as regards tint) in order to meet the specification of the intended products, said specification being particularly demanding in the case of flat glass for buildings or motor vehicles.

The auxiliary glass generally represents at most 20%, in particular 0.5 to 20% and more generally 1 to 15% and even 2 to 10%, of the mass of the final glass.

To maintain the dough quality of the final glass and in particular to ensure a low bubble content, it is preferable to make sure that the two glasses to be mixed are consistent from the standpoint of oxidation-reduction: thus, if we call the “redox” of an ion of a metal the ratio of the quantity (molar or by mass) of this ion to the total quantity of the same metal, preferably, for a given metal, the redox values of the various ions, on the one hand, in the main glass and on the other hand in the auxiliary glass do not differ by more than 0.1. To take an example, in the case of the metal iron, if the redox of the Fe²⁺ ion in the main glass is 0.2, the redox of the Fe²⁺ ion in the auxiliary glass is preferably 0.2±0.1.

Preferably, the two glasses are mixed while they are substantially at the same temperature, that is to say when the difference in their temperatures is at most 100° C. In general, when mixing the auxiliary glass with the main glass, they both have a temperature ranging from 1100 to 1300° C. and even between 1100 and 1200° C.

This concern in correspondence between the two glasses from the temperature and redox standpoint stems from the fact that excessively large differences may be the cause of a new formation of bubbles as soon as they are mixed.

When the auxiliary furnace comprises at least one submerged burner, one advantage of the surmerged burner is to have the sulfate content (generally expressed as percent of SO₃) in the auxiliary glass lowered. This is because the water produced by the combustion gases, which stir the auxiliary glass effectively, strip almost all of the sulfate from the auxiliary glass. Thus, the auxiliary glass may not be a source of bubbles coming from gaseous evolution of SO₂. The auxiliary glass may be used merely to influence the redox of the final glass. This is because the solubility limit of sulfate in a glass can be represented by a decreasing curve when the redox (in particular the Fe²⁺ redox) increases. Thus, there is a general tendency to generate undesirable SO₂ bubbles when the redox increases. This is why it is generally not obvious to mix two glasses with a different redox. The use of a furnace with submerged burners for producing the auxiliary glass provides a solution to this problem since, as the auxiliary glass is stripped of its sulfate, the addition of the auxiliary glass amounts to as it were diluting the sulfate present in the main glass and therefore moving further away from the solubility limit. The risk of bubble formation is therefore reduced. This gives the process flexibility as it is possible to take advantage of this dilution in order to slightly increase the redox of the final glass by preparing an auxiliary glass with a slightly higher redox. In particular, the submerged burner technology allows the temperature at which the auxiliary glass is prepared to be lowered in comparison with another heating technology, such as electric heating. This is advantageous as it allows the temperature of mixing of the two glasses, advantageously lower than the temperature at which the two glasses to be mixed are prepared, to be much more rapidly approached. Lowering the temperature has the effect of moving further away from the sulfate solubility limit. Thus, the process according to the invention using the technique of submerged burners for the auxiliary furnace makes it possible to produce a glass colored by iron oxide ranging from green up to blue, thanks to the possibility of varying the Fe²⁺ redox over a very wide range.

Thus, the invention relates especially to the process whereby:

the auxiliary furnace strips the auxiliary glass of almost all of the sulfates present in the batch materials feeding it; and

the auxiliary glass has a higher iron content than that of the main glass and a higher Fe²⁺ redox than that of the main glass.

The invention especially relates to the process whereby the auxiliary glass has an almost zero sulfate content, the main glass has a sulfate content ranging from 0.2 to 0.35%, expressed as % by weight of SO₃, and the auxiliary glass has a higher Fe²⁺ redox than the main glass and a higher iron content than the main glass.

As an example, a main glass may be prepared in a furnace with overhead burners, having the following characteristics:

0.24% SO₃;

Fe²⁺ redox: 0.23;

Fe content: 900 ppm by weight;

preparation temperature: 1450° C.;

percentage of the final glass: 90%

and an auxiliary glass in a furnace with a submerged burner, having the following characteristics:

0% SO₃;

Fe²⁺ redox: 0.36;

Fe content: 4.3% by weight;

preparation temperature: 1200° C.;

percentage of the final glass: 10%.

These two glasses were mixed at 1150° C. in order to produce a final glass with the following characteristics:

0.22% SO₃;

Fe²⁺ redox: 0.34;

Fe content: 0.51% by weight.

It is not known at the present time how to produce a glass with as high a redox in a conventional furnace with overhead burners, because of the difficulty in controlling the redox.

The furnace for producing the main glass is generally fed with conventional batch materials in the form of powder, and where appropriate partly with cullet. The amount of cullet generally represents 5 to 25% of the mass of the raw materials feeding the main furnace.

The furnace for producing the auxiliary glass may be fed in several ways:

either with cullet, for example from a return line (that is to say coming from the cutting or breaking of glass downstream of the main plant);

or with a conventional batch composition, generally in powder form,

or with molten glass coming from an upstream tap-off from the main glass stream;

or with a coloring frit, especially when it is desired to color the glass with chromium oxide;

or by a combination of at least two of these means.

To feed the auxiliary furnace, in some cases (for example when it is unnecessary to recycle the return line cullet), it may be advantageous to tap off the main glass upstream of the point where the two streams are mixed, for example in a conditioning zone after the main furnace. The energy to be supplied to the auxiliary furnace is then considerably reduced.

The colorants (or pigments) that can be used as a particular compound with a different concentration in the main glass from the auxiliary glass within the context of the present invention are in general very fusible oxides (those of iron, cobalt, nickel, etc.). If the final glass has to contain a chromium oxide, this could be introduced into the auxiliary furnace in frit form so as to minimize the risk of batch stones being present in the final glass. Chromium oxide is generally used only to give the glass a green or yellow color, or else it is present in addition to cobalt oxide in the case of a blue glass.

The auxiliary glass melting furnace advantageously includes a heat recovery system aiming to heat, by means of the flue gasses that it generates, the raw materials (such as cullet) with which it is fed (the flue gases flowing countercurrently with respect to the incoming raw materials). Thus energy is saved, this being advantageous especially when the furnace operates with a combustible gas and with pure oxygen, the simplest system for submerged combustion.

The process and the plant according to the invention generally comprise, downstream from the point where the two glasses are mixed, where appropriate in a mixing cell, a forming station, which may be a float glass furnace, a rolling station or a hollowware forming station.

The main glass generally comprises at least 55% by weight of silica (SiO₂). The main glass generally comprises less than 5% by weight of alumina.

The main glass generally comprises:

65 to 75% by weight of SiO₂;

10 to 15% by weight of Na₂O;

7 to 11% by weight of CaO (acting as an outflow promoter).

The main glass may in addition also include:

0 to 5% by weight of B₂O₃;

0 to 5% by weight of MgO;

0 to 2% by weight of alumina;

0 to 2% by weight iron oxide;

0 to 200 ppm by weight of selenium (in its metal form);

0 to 500 ppm by weight of cobalt oxide;

0 to 1000 ppm by weight of chromium oxide;

0 to 1000 ppm by weight of copper oxide;

0 to 2000 ppm by weight of nickel oxide;

0 to 1% by weight of tungsten oxide;

0 to 2% by weight of cerium oxide;

0 to 2% by weight of titanium oxide; and

0 to 2500 ppm of uranium oxide.

The auxiliary glass generally comprises at least 50% and even at least 55% by weight of SiO₂. The auxiliary glass generally comprises less than 5% by weight of alumina.

The auxiliary glass generally comprises:

50 to 75% by weight of SiO₂;

8 to 15% by weight of Na₂O;

0 to 5% by weight of B₂O₃; and

0 to 2% by weight of alumina.

The compound having a content different in the main glass from that in the auxiliary glass may be a pigment, which may for example be at least one of the following:

an oxide of a metal (other than Si, Na, B and Al) such as iron, chromium, cobalt, copper, nickel, zirconium, titanium, manganese, praseodymium, zinc, cerium, neodymium, erbium, vanadium, and tungsten;

selenium (in its metal form).

Where appropriate, the compound having a content different in the main glass from that in the auxiliary glass may be lead oxide, even in a very substantial quantity (for example 30% by weight). This is because lead oxide in a glass may serve to absorb X-rays. Since this oxide is particularly corrosive to refractories, it is particularly advantageous to introduce it into the final glass via the auxiliary plant, since in this way it is the smaller auxiliary plant that will be exposed to its harmfulness and the main plant will be spared therefrom. Thus, the refractories will be subject to less wear. Of course, this does not exclude the main glass from also containing lead oxide.

Where appropriate, the particular compound is generally present in the auxiliary glass with a content ranging from 20 ppm by weight to 30% by weight. According to the invention, the compound having a content different in the main glass from that in the auxiliary glass may be an oxide of a metal other than Si, Na, B and Al. This oxide may be the origin of a coloration of the auxiliary glass visible to the naked eye, said oxide being present in the auxiliary glass with a content greater than that of the same oxide in the main glass (the main glass may therefore contain none of this oxide). Thus, the particular compound may be a pigment present in the auxiliary glass with a content higher than the content of the same pigment in the main glass and with a content sufficient to give the final glass a coloration visible to the naked eye.

Any particular compound in the auxiliary glass or the main glass or the final glass is present therein with a content below its solubility limit in said glass, said limit possibly depending on the composition of said glass.

Thus, especially when the function of the auxiliary glass is to increase the absorbent nature, it may generally comprise at least one of the following elements in the quantities mentioned:

0 to 30% and more particularly 0.5 to 20% by weight of iron oxide;

0 to 1.5% and more particularly 20 ppm to 1% by weight of selenium;

0 to 2% and more particularly 20 ppm to 2% by weight of cobalt oxide;

0 to 2% and more particularly 20 ppm to 2% by weight of chromium oxide;

0 to 5% and more particularly 50 ppm to 5% by weight of nickel oxide; and

0 to 15% and more particularly 0.5% to 10% by weight of cerium oxide.

When the function of the auxiliary glass is to increase the absorbent nature by means of a particular compound, said glass contains at least said compound in a larger amount than the main glass (which may therefore contain none of said compound) so as to increase the content of this compound in the final glass relative to the main glass. In particular, the auxiliary glass may contain iron oxide in a quantity sufficient to give the final glass a green coloration visible to the naked eye. If it is a case in which the final glass is given a green color thanks to the iron oxide contained in the auxiliary glass, this means in particular that if the main glass already contains iron oxide, the auxiliary glass contains more of it (higher content) so that to the naked eye the final glass has a more pronounced green coloration than the main glass.

The main glass may include at least one ion of a metal other than Si, Na, B and Al, said ion also being contained in the auxiliary glass and the difference in redox of this ion between, on the one hand, the main glass and, on the other hand, the auxiliary glass not being greater than 0.1.

Between the main glass and the auxiliary glass there is a difference in the content of at least one compound. This difference in content is generally at least 10% of the higher content (in % by weight) of these two glasses and it may range up to 100%. Thus, to take an example, if a particular compound is present in an amount of 0% in one of these two glasses and in an amount of 20% in the other, the difference in content is 20−0=20, i.e. 100% of the higher content.

In particular, the invention relates to a flat glass containing iron oxide, giving it a uniform green coloration through its thickness and also a flat glass containing iron oxide giving it a uniform blue coloration through its thickness (in the bulk). Such glass may be produced as a ribbon more than 2 m in width by a plant in which it floats on a bath of molten metal.

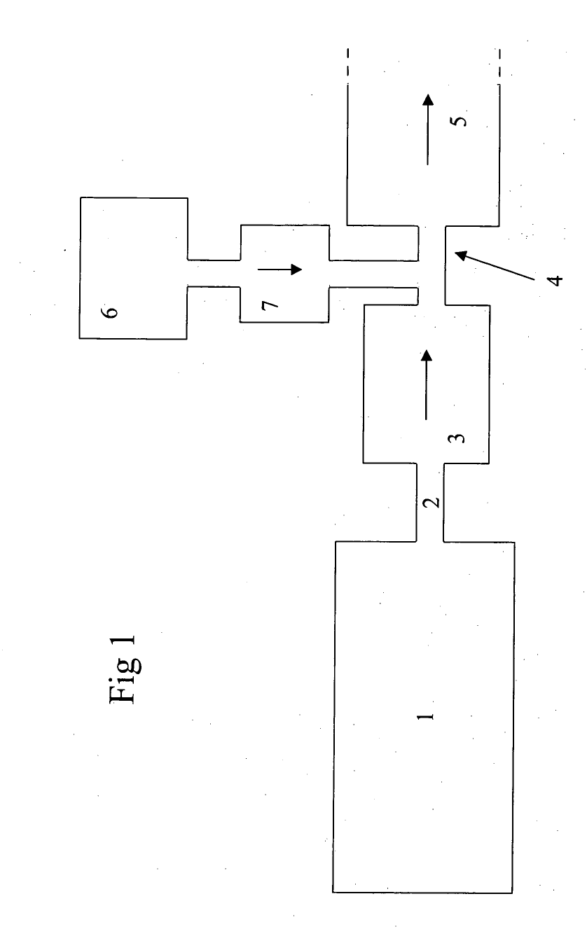

FIG. 1 shows highly diagrammatically one embodiment of the invention. The charging with the raw materials has not been shown in this figure. The main plant comprises a furnace 1 and a conditioning zone 3. The furnace 1, fitted with atmospheric burners, fed with batch materials in powder form and/or cullet, produces a main glass flowing through the waist 2 into the conditioning zone 3 (for thermal conditioning), said main glass feeding, via the feeder 4, a float glass forming station 5 for producing flat glass. The feeder 4 receives an auxiliary glass produced in a furnace 6 fitted with submerged burners, the glass from which is refined at 7. The auxiliary plant comprises the furnace 6 and the refiner 7. The two (main and colored) glasses are mixed in the feeder 4 which is provided with mechanical homogenizers (stirrers), before the mixture thereof reaches the float station 5, only just the first part of which has been shown.

Examples of the manufacture of tinted automobile glasses are described below.

### EXAMPLES

The plant according to the invention consists of a main furnace (also called a melter) fitted with transverse atmospheric burners, having a floor area of 350 m², operating with a molten glass depth of 1.5 m, and of an auxiliary furnace fitted with submerged burners, with a floor area of 3 m², the two glass streams being mixed in a coloring cell having a floor area of about 24 m² and comprising 2 or more rows of stirrers, the outside diameter of the blades of which is 500 mm.

The main furnace produces, continuously, a lightly colored glass containing 0.6% iron oxide with an Fe²⁺ redox of 0.30 with a pull rate of 600 t/d (metric tons per day). Continuous operation is favourable to the quality of the glass produced and to the lifetime of the furnace. To achieve a final glass containing 0.85% iron oxide, 30 t/d of an auxiliary glass containing 5.85% iron oxide is added. This requires about 28 t of cullet per day, i.e. only part of the return line cullet, the other part being introduced into the main furnace in an amount suitable for producing glass containing 0.6% iron oxide. The total pull rate of the line is then 630 t/d: in conventional melting (that is to say with the colorants being introduced at the batch charging end), the pull rate would have to be dropped to about 560 t/d.

To make a tinted grade containing 1% iron oxide, the pull rate of the auxiliary furnace may be raised to about 46 t/d with the same rate of introduction of iron oxide (the floor area is then about 4.5 m²), or this content may be raised to 9% with the same 30 t/d pull rate. In the first case, the total pull rate reaches 646 t/d, whereas in conventional melting (only a single melting furnace) this would not exceed 550 t/d.

The transition takes place by a transition in the auxiliary furnace: the ratio of the resident glass to the pull rate is approximately 7.5 t/50 t/d, i.e. 0.15 days. The transition (which can be shortened further by using a color concentrate) is completed in about 0.15×3=0.45 days. Over this time, the glass from the auxiliary furnace is preferably not introduced into the main furnace.

The duration of the coloring or decoloring transition in the main furnace is thus at most of the order of half a day, which is much less than the 3 to 5 days needed with a conventional configuration, that is to say a single furnace with the same total pull rate, coloring frits being added to the stream therefrom before the forming step.

1-26. (Cancelled)

27. A process for manufacturing a glass, comprising
(i) producing a main stream of a liquid main glass by a main plant that comprises a main furnace,
(ii) producing an auxiliary stream of a liquid auxiliary glass by an auxiliary plant that comprises an auxiliary furnace, wherein
the auxiliary stream is smaller than the main stream,
the auxiliary glass has a different composition from the main glass, and
(iii) mixing the two streams to form a single total stream of a final glass,
wherein the auxiliary furnace comprises at least one submerged burner.

28. The process according to claim 27, wherein the auxiliary plant comprises a refiner located after the auxiliary furnace.

29. The process according to claim 27, wherein the auxiliary stream represents at most 20% of the total stream.

30. The process according to claim 27, wherein the final glass is converted into flat glass by a float glass station.

31. The process according to claim 30, wherein the flat glass has a width of greater than 2 metres.

32. The process according to claim 30, wherein the flat glass has a width of greater than 3 metres.

33. The process according to claim 27, wherein the main glass contains at least 55% by weight of silica and less than 5% by weight of alumina.

34. The process according to claim 27, wherein the auxiliary glass contains at least 50% by weight of silica and less than 5% by weight of alumina.

35. The process according to claim 27, wherein the auxiliary glass has a different composition than the main glass with respect to at least one compound, wherein said compound is present in the auxiliary glass at a content ranging from 20 ppm by weight to 30% by weight.

36. The process according to claim 27, wherein the auxiliary glass has a different composition than the main glass with respect to at least one compound, wherein said compound is a pigment selected from:
an oxide of a metal selected from the group consisting of iron, chromium, cobalt, copper, nickel, zirconium, titanium, manganese, praseodymium, zinc, cerium, neodymium, erbium, vanadium, and tungsten; or
selenium.

37. The process according to claim 27, wherein the auxiliary glass has a different composition than the main glass with respect to at least one compound, wherein said compound is a pigment present in the auxiliary glass at a content greater than the content of the same pigment in the main glass and at a content sufficient to give the final glass a coloration visible to the naked eye.

38. The process according to claim 27, wherein the auxiliary glass has a different composition from that of the main glass with respect to at least one compound, said compound being iron oxide giving a green-to-blue coloration.

39. The process according to claim 27, wherein when mixing the auxiliary glass with the main glass, both have a temperature ranging from 1100 to 1200° C.

40. The process according to claim 27, wherein the auxiliary furnace strips the auxiliary glass of almost all of the sulfates present in the batch materials feeding it, the auxiliary glass having a higher iron content than that of the main glass and a higher Fe²⁺ redox than that of the main glass.

41. The process according to claim 27, wherein the auxiliary glass has an almost zero sulfate content, the main glass has a sulfate content ranging from 0.2 to 0.35%, expressed as % by weight of SO₃, the auxiliary glass having a higher Fe²⁺ redox than the main glass and a higher iron content than the main glass.

42. The process according to claim 27, wherein the auxiliary glass contains 0.5 to 20% iron oxide by weight

43. The process according to claim 27, wherein the main furnace operates with a specific pull-rate ranging from 1.4 to 2 t/d.m² and a molten glass depth of greater than 1 metre and wherein the auxiliary furnace operates with a specific pull-rate ranging from 5 to 20 t/d.m².

44. The process according to claim 27, wherein the auxiliary furnace has a floor area ranging from 1 to 50 m² and wherein the main furnace has a floor area ranging from 200 to 600 ml.

45. A plant for manufacturing a glass obtained by the process of claim 27, comprising a main plant which comprises a main furnace generating a main stream of glass, and an auxiliary plant, which comprises an auxiliary furnace heated mainly by at least one submerged burner and generating an auxiliary stream of an auxiliary glass, the two streams then being mixed to form a single total stream generating the final glass.

46. The plant according to claim 45, wherein the main furnace is heated mainly by at least one atmospheric burner.

47. The plant according to claim 45, further comprising, after the point where the two streams are mixed, a continuous flat glass forming station.

48. The plant according to claim 45, wherein the auxiliary furnace has a floor area ranging from 1 to 50 m² and wherein the main furnace has a floor area ranging from 200 to 600 ml.

49. A glass manufactured according to the process of claim 27.

50. A glass manufactured by the plant according to claim 45.

51. A flat glass containing iron oxide giving it a uniform green coloration through the thickness.

52. A glass containing iron oxide giving it a uniform blue coloration through the thickness.

53. A ribbon more than 2 m in width comprising the glass of claim 51.

54. A ribbon more than 2 m in width comprising the glass of claim 52.
